(19) United States
(12) Patent Application Publication
(10) Pub. No.: US 2016/0314694 A1
(43) Pub. Date: Oct. 27, 2016

(54) SYSTEM AND METHOD FOR TRAINING EDUCATORS

(71) Applicant: METIS Leadership Group, LLC, Island Heights, NJ (US)

(72) Inventors: Thomas F. Brock, Cerritos, CA (US); Michael R. Robinson, Island Heights, NJ (US)

(21) Appl. No.: 15/140,373

(22) Filed: Apr. 27, 2016

Related U.S. Application Data
(60) Provisional application No. 62/153,422, filed on Apr. 27, 2015.

(51) Int. Cl. G09B 3/02; G09B 19/00

(52) U.S. Cl. CPC G09B 3/02; G09B 19/00

(57) ABSTRACT

The present invention is generally a system and method for training educators by implementing an interactive goal-focused communication (GFC) protocol, and more specifically, to a system and method of teaching that includes a GFC protocol for interactively engaging students in a type of dialogue that improves student performance. In one embodiment, the invention includes a learning management system (LMS) comprising a computer readable medium for providing a user interface that enables instruction of the GFC protocol between client users. The users of the LMS include mentor-clients and educator-clients, which may access the system to manage or keep track of their progress.

### PRIORITY NOTICE

The present application claims priority under 35 U.S.C. §119(e) to U.S. Provisional Patent Application Ser. No. 62/153,422 filed on Apr. 27, 2015, the disclosure of which is incorporated herein by reference in its entirety.

### TECHNICAL FIELD OF THE INVENTION

The present invention relates in general to a system and method for training educators. More specifically, the present invention relates to a system and method for training educators to improve their student's achievement by implementing an interactive goal-focused communication protocol via, for example, a learning management system.

### COPYRIGHT AND TRADEMARK NOTICE

A portion of the disclosure of this patent application may contain material that is subject to copyright protection. The owner has no objection to the facsimile reproduction by anyone of the patent documents or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

In the past, teaching mechanisms have focused on providing rigid or specific goals to students, by way of guiding the student with a particular curriculum that includes goals set by educators for the students. However, students learn better and are more cooperative when they believe school is relevant to their own personal goals and they take ownership for learning. One problem with some prior methods implemented by educators is that their teaching curriculums focus exclusively on completing a specific task. The present invention, trains educators to focus their students on the student's personal achievement.

Research in the field of education has revealed that several things must occur in order for students to focus on their personal achievement: (i) there must be a productive teaching relationship between the student and the educator; (ii) students must recognize the relevance of schoolwork to their personal goals—whether career goals, school goals, or classroom goals; and (iii) students must take personal responsibility for learning and doing the things they identify as necessary to achieving their personal goals.

Therefore, there is a need in the art for a system that enables training educators to help their students focus on achievement by: focusing on personal, career, school, and or classroom goals; identifying relevance for their own learning; taking responsibility for their own learning; and employing a sound protocol for achieving their goals, solving problems, and learning new things. Through research, developments, and extensive testing, a protocol has been conceived that may be taught to educators for implementing with their students. It is to these ends that the present invention has been developed.

### SUMMARY OF THE INVENTION

To minimize the limitations in the prior art, and to minimize other limitations that will be apparent upon reading and understanding the present specification, the present invention describes a system and method for training educators. More specifically, a system and method of teaching is disclosed, which includes a goal-focused communication (GFC) protocol for interactively engaging students in a type of dialogue that improves student performance. In one embodiment, the invention includes a learning management system (LMS) comprising a computer readable medium for providing a user interface that enables instruction of the GFC protocol between client users. The users of the LMS include mentor-clients and educator-clients, which may access the system to manage or keep track of their progress. In other embodiments, training of each educator may be accomplished in a live, in-person setting between mentors of the service provider and the educators seeking to improve their effectiveness as teachers.

The present system and method seeks to equip teachers, counselors, support staff, and school leaders (or educators) with strategies that make the classroom relevant to students so that they are personally invested in their school success. The present invention equips the educator with the means to enable students to clarify their personal career, school, and classroom goals. The present invention shows educators how to move the locus of responsibility for achievement onto the student. Hence, immediate outcomes of the present system and method may include: creating a productive relationship between the student and the educator; affirming the relevance of the school and the classroom to the student's personal goals; and allocating the locus of responsibility for learning to the student rather than the educator.

A method for training an educator to improve their students' achievement using GFC conversations presented via a learning management system, in accordance with the present invention, comprises the steps of: instructing the educator to observe a media presentation of a first GFC conversation between GFC participants, wherein the first GFC conversation includes a first GFC question set initiated by a first participant and comprising of: a first request for a target goal of a second participant, a second request for a scale value associated with the second participant's perceived proximity to achieving the target goal, and a third request for a plan of the second participant to achieve the target goal; instructing the educator to evaluate the first GFC conversation based on predetermined criteria; and instructing the educator to formulate a second GFC question set for initiating a second GFC conversation with a student of the educator, wherein the predetermined criteria include: providing an affirmation, providing a reasoned statement for initiating GFC conversations, utilizing congruent verbal and non-verbal messages; and utilizing non-critical language.

A system for training educators, in accordance with one embodiment of the present invention, comprises: an LMS including a computer readable medium for providing a user interface configured to train client users to conduct a GFC protocol; a database of institutions, mentors, and educators; and a network interface for connecting the LMS to the client users, wherein the client users of the LMS include mentoring clients and educator clients, which may access the system to manage or keep track of their progress.

A method for training educators, in accordance with one embodiment of the present invention, comprises the steps of: providing mentor and an educator access to a learning management server; assigning a mentor-client to an educator-client; providing a user interface accessible via the learning management server; providing instruction materials associated with a GFC protocol via the user interface; providing a set of GFC guidelines via the user interface; providing, to the educator-client, a demonstration associated with the GFC protocol; receiving feedback from the educator-client concerning the demonstration; receiving feedback from the mentor-client; approving the educator-client for a live GFC protocol; enabling collaboration between mentor-client and educator-client; and providing certification of completion to the educator-client.

A method for facilitating a goal-focused communication protocol, in accordance with one embodiment of the present invention, comprises the steps of: formulating a question set; engaging a student; applying a set of predetermined criteria to the question set; formulating follow-up procedures; and setting up an appointment to re-engage with the student, wherein the question set comprises: requesting a target goal; requesting a scale value; and requesting a proposed plan to achieve the target goal.

Another method for training an educator to improve their students' achievement in accordance with the present invention, comprises the steps of: instructing the educator to observe a presentation of a first GFC conversation between GFC participants, wherein the first GFC conversation includes a first GFC question set initiated by a first participant and comprising of: a first request for a target goal of a second participant, a second request for a scale value associated with the second participant's perceived proximity to achieving the target goal, and a third request for a plan of the second participant to achieve the target goal; instructing the educator to evaluate the first GFC conversation based on predetermined criteria; and instructing the educator to formulate a second GFC question set for initiating a second GFC conversation with a student of the educator.

It is an objective of the present invention to provide educators with the tools to focus their students on achievement.

It is another objective of the present invention to empower educators with facilitating the professional development of others.

It is yet another objective of the present invention to provide a system for training educators.

These and other advantages and features of the present invention are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1 illustrates a system in accordance with one embodiment of the present invention.

FIG. 2 illustrates a computer-readable medium for providing a user interface configured to train client users to conduct a GFC protocol.

FIG. 3 illustrates one embodiment for a user interface in accordance with the present invention.

FIG. 4 illustrates one embodiment for a user interface in accordance with the present invention.

FIG. 5 is a block diagram of a kit-component of a system in accordance with the present invention.

FIG. 6 is a flowchart depicting a method for training educators, in accordance with practice of one embodiment of the present invention.

FIG. 7(a) is a flowchart depicting a method for facilitating a GFC protocol, in accordance with practice of one embodiment of the present invention.

FIG. 7(b) is a flowchart depicting a method for training an educator to conduct a GFC conversation in accordance with practice of one embodiment of the present invention.

FIG. 8 is a flowchart depicting a GFC protocol, in accordance with practice of one embodiment of the present invention.

FIG. 9 illustrates a sample skill sheet that may be provided to an educator while they work through the program.

FIG. 10 illustrates an exemplary evaluation form, or rubric for evaluating each GFC conversation.

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the following detailed description, a service provider may be a cause-focused organization, whether for profit or non-profit, a school district, an institution such as a university, a high school, an education consulting firm, or any other provider of services in the educational field. In an exemplary embodiment, the service provider may include experienced psychologists and educators trained for providing practical wisdom to establish a culture of achievement in schools; these trained professionals may be referred to as mentors. A learning management system (LMS) may be hardware and software components for the administration, documentation, tracking, reporting and delivery of electronic educational technology for providing education courses or training programs. Such LMS may include for example a computer readable medium for executing a set of instructions configured to provide the documentation, tracking, reporting and delivery of electronic educational materials in accordance with the present invention. The LMS may include a user interface, such as a mobile application or a website interface for enabling users of the LMS to interact. A user interface of the LMS may be configured to facilitate providing pre-recorded, or live feeds of, goal-focused communication (GFC) conversations between participants, and other examples of GFC protocols or GFC questions sets, so that the educators can watch, evaluate, practice and develop GFC conversations including GFC question sets with their own students. Similarly, the mentors can use the LMS to provide guidance and evaluate each educator's progress.

As will be explained further below, a GFC conversation refers to a goal-focused communication conversation between participants (which may be pre-recorded or provided via live feed, or even performed in a class-room) in which one participant implements a GFC protocol or GFC question set into the conversation. A GFC protocol or GFC question set may refer to a list of predetermined questions (with a very specific question format) that may be implemented into a conversation. For example, a GFC question set includes a first request for a target goal of a second participant, a second request for a scale value associated with the second participant's perceived proximity to achieving the target goal, and a third request for a plan of the second participant to achieve the target goal. GFC conversations may be presented to educators for evaluation, analysis, and training via the LMS or in a live, in-person setting between mentors of the service provider and the educators seeking to improve their effectiveness as teachers.

Generally, the present invention involves a system and method for training educators, including an LMS administered by a service provider that offers consulting services in the field of education. The service provider may connect various institutions with its services via the LMS, which the service provider uses to train educators with a goal-focused communication protocol or technique developed to maximize student achievement. The LMS may include a computer readable medium, for example a server, for providing a user interface configured to train client users to conduct the GFC protocol. The server may include one or more databases for storing information associated with institutions, mentors, and educators, which will be utilizing the LMS. A network interface may connect client users via a network such as the internet, wherein the client users of the LMS include mentoring clients and educator clients, which may access the system to manage or keep track of their progress. The service provider may provide mentor clients and educator clients access to the LMS, and assign an educator to a mentor. The LMS may further provide software including a user interface configured to provide documentation, media, support, and other information for training the educator to perform a GFC protocol. For example, the user interface may provide instruction materials, guidelines, and demonstrations associated with a GFC protocol in a manner so that the mentor may follow the educator's progress. In exemplary embodiments, the user interface may be configured to receive feedback from the educator client, receive feedback from the mentor client, allow the mentor to check the educator's work, enable collaboration between mentor and educator, and provide certification to the educator once the educator has completed a predetermined program curriculum.

One aspect of the present invention is a unique method of teaching involving a communication or dialogue protocol, which enables an educator to improve a student's learning experience. When applied correctly, the GFC protocol facilitates a productive relationship between the student and educator, which changes the locus of responsibility from educator to student. This practice enables the student to take charge of their achievement. In one embodiment, a form of this protocol is a structured dialogue that may be referred to as a GFC conversation. As mentioned above, the dialogue is based on three GFC protocol questions asked of the student: (1) a first request for a target goal of a second participant, which may be implemented (by way of example) as “What is your goal?” (i.e. a request that solicits from the student a clarification of the goal of the student—from the student's perspective); (2) a second request for a scale value associated with the second participant's perceived proximity to achieving the target goal, which may be implemented (by way of example) as “On a scale of 1-10 where are you now? (i.e. a request for the student to provide a value on an arbitrary scale, which enables the student and educator to monitor progress); and (3) a third request for a plan of the second participant to achieve the target goal, which may be implemented (by way of example) as “How will you move up the scale?” (i.e. a request for a plan proposal, which enables the student to identify resources and/or means to achieve their stated goal). Hence, the GFC protocol causes students to identify the first thing they will do to get closer to their goal, has them set a time with their teacher to review their progress, and identify their next steps.

When GFC conversations are used by educators for career planning—determining long-term school goals, and short term, in-the-moment, activity goals—several things occur: productive teaching-relationships develop between student and educator; students recognize the relevance of schoolwork and accept its importance to their goals; and students employ the GFC structure and take responsibility for their own learning and behavior. As such, the present invention yields a school culture focused on student achievement by training its educators to conduct GFC conversations with their students.

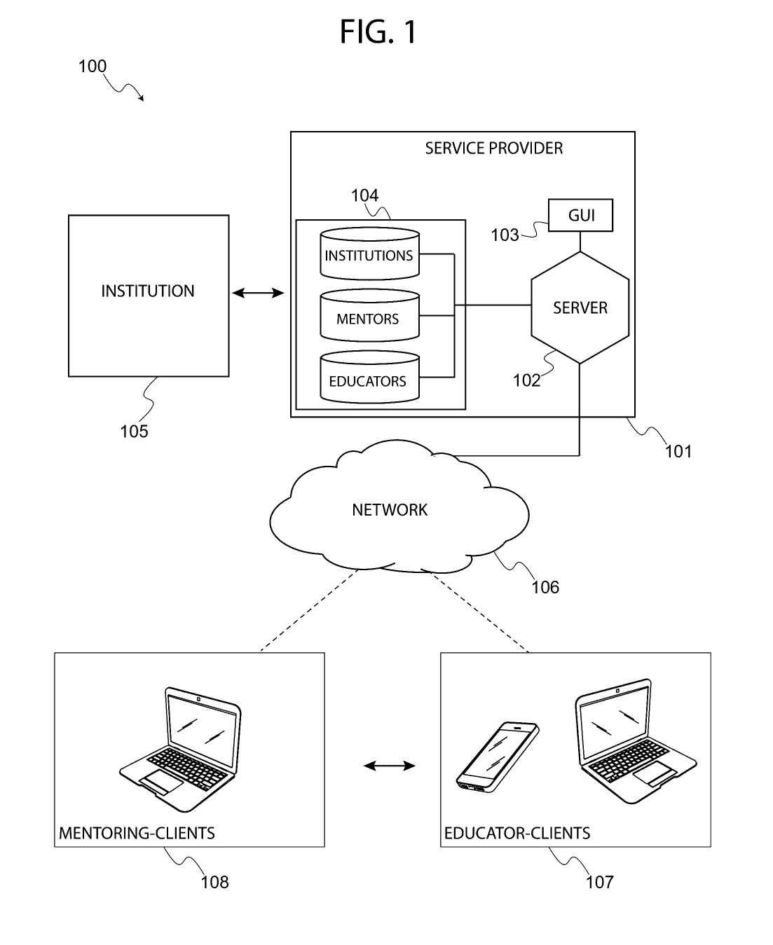

Turning now to the figures, FIG. 1 illustrates a system in accordance with one embodiment of the present invention. More specifically, FIG. 1 shows system 100, which includes service provider 101 hosting a learning management system comprising server 102, software module 103, and database 104. Typically, service provider 101 communicates with one or more institutions 105 such as schools or school districts. For example, and without limiting the scope of the present invention, one or more institutions 105 may contact service provider 101 to consult with the institution for improving that institution's educational program. Service provider 101 may provide mentors to the institution's educators and assign a mentor to one or more educators that will partake in the program. As such, educators from one or more of institutions 105 may be designated access to server 102 as educator clients 107 of system 100. Similarly, the mentors from service provider 101 may be designated access to server 102 as mentoring clients 108 of system 100.

Accordingly, educator clients 107 are users with access to server 101, who may be teachers, counselors, support staff, or school leaders that may benefit from training by service provider 101. Mentoring clients 108 are users with access to server 101, who may be trained individuals with the knowledge and experience to train educator clients 107.

Typically, service provider 101 facilitates remote communication between educator clients 107 and mentoring clients 108 via a network 106 such as the internet, so that these users may connect to the server 102 and access a graphical user interface (GUI) that facilitates the viewing and sharing of instructional information (as well as other communications) between educator clients 107 and mentoring clients 108—the instructional information comprising of media, documents, lesson plans, and other tools that facilitate teaching the GFC protocol.

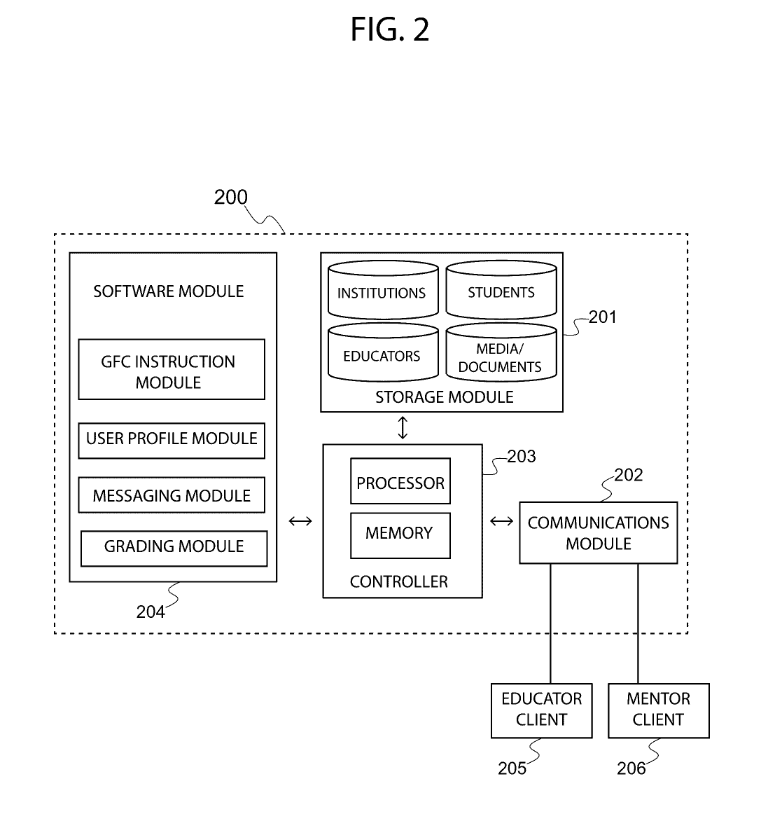

FIG. 2 illustrates a computer-readable medium, for example server 200, for providing a user interface configured to train client users to conduct a GFC protocol via the LMS. Whatever architecture, technique or manner in which server 200 is implemented, server 200 is typically configured to: provide mentor clients and educator clients access to the LMS server; create a profile associated with at least one mentor; create a profile associated with at least one educator; associate a mentor profile with an educator profile; provide a user interface configured to provide instruction materials associated with a GFC protocol; provide GFC protocol guidelines via the user interface; provide a demonstration associated with the GFC protocol such as prerecorded media for displaying a GFC conversation; receive feedback from the educator client and providing the feedback to the mentoring client; receiving feedback from the mentoring client; clear an educator for a live GFC protocol session; enable collaboration between mentoring client and educator client; and provide the educator with a certification of completion of the program offered by the service provider.

Naturally, server 200 may be configured with any known techniques and in any known manner to achieve a desired security and functionality. In exemplary embodiments, server 200 includes storage module 201, communications module 202, control module 203 and software module 204. Moreover, server 200 is configured to communicate with educator client 205 and mentor client 206.

Server 200 may comprise a two tier server setup with one database layer and one application (web server) layer. This may allow the system to scale user wise by load balancing the application layer and also provide increased security. A cloud based system may run on servers in the Amazon Virtual Private Cloud environment. All physical documents as well as database backups may be encrypted and stored in Amazon's Simple Storage Service (S3). For disaster recovery purposes the system may implement a backup of all current layer images stored in S3 and backups of the database performed incrementally every X minutes and full daily backups. For high availability (and also disaster recovery) purposes based on the service provider's requirements, the system may address failover clustering the database server as well. All security and firewalls may be configured using best practices and industry standard methods. Access to servers may be limited and monitored. All system access attempts (success or failure) may be logged in the database and physical log files as well as access to any base entities.

In other embodiments, server 200 may be a distributed server system set up for robustness in case one server fails. In such exemplary embodiment, server 200 is a World Wide Web (WWW) server connected to the internet. Server 200 may comprise representational state transfer (REST) architecture. Although other architectures may be implemented, a REST server may be desirable to maximize efficiency, particularly in systems that may experience an increasing amount of requests. Furthermore, similar architectures may provide a centralized means of connecting with other system components such as third-party applications or websites that may provide services including websites or mobile device applications and geographic location services. Server 200 may comprise of a plurality of distributed servers configured for fault tolerance, duplication and backup capabilities.

Storage module 201 may be coupled either externally or internally to server 200. For example, storage 201 may be one or more long term memory storage devices, such as a hard drive, disk drive, tape unit, Network Attached Storage (NAS) device, Storage Attached Network (SAN) device, RAID disk array, or optical disk array. Although typically a long term memory storage device, storage 201 may be any other memory device without departing from the scope of the present invention. In an exemplary embodiment, storage 201 is striped across redundant storage containers or RAID disk array in a SAN environment for increased data access speeds and robustness. Of course, any other storage configuration would not deviate from the scope of the present invention so long as storage 201 is suitable for the needs of server 200. In one exemplary embodiment, storage module 201 is a cloud-based storage solution suitable to host one or more databases for the system managed by server 200.

Storage module 201 may hold multiple databases containing data objects within data repositories collected by server 200. The databases of storage module 201 may be created by a known database manager using known technologies such as relational architecture and SQL access, such as Microsoft™ SQL or Oracle™ DB. However, the database of storage module 201 may be as simple as a series of files stored in a directory, with a text file listing filename locations without departing from the scope of the present invention. In one embodiment, the one or more databases of storage module 201 may be a combination of a known database manager, and an organized directory tree structure, wherein the database manager stores text information in the database itself, but stores multimedia information and other non-text information as filename locations of files stored in an organized directory tree structure.

In an embodiment wherein server 200 relies on cloud computing, storage module 201 may include technologies offered by Amazon™ such as Amazon™ Elastic Compute Cloud (AWS EC2), whereby storage module 201 may employ MySQL™ and AWS EC2™ instances.

The one or more databases of storage module 203 may hold multiple data repositories corresponding to: institutions or institution clients, students, educators, media, and learning documentation. For example, and without limitation, storage module 203 may include prerecorded GFC conversations between participants, which may be shown to an educator as part of their training. Other documentation such as sample rubrics, skill sheets, and any other learning material may also be stored in electronic form in the one or more databases of storage module 201.

Communications module 202 may be implemented as a single device or multiple devices configured to connect server 200 to a network such as the internet, and or communicate server 200 to other system components such as client devices of the mentors and educators (i.e. educator client 205 and mentor client 206).

Control module 203 typically includes one or more processors and memory configured to execute a set of one or more executable instructions such as program code and/or data stored on one or more computer readable mediums to implement the various applications, data, steps described below and any other instructions pertinent to the functions of server 200. For example, such executable instructions may be included in software module 204.

Software module 204 may include one or more modules for the various functions of the system managed by server 200. For example, software module 204 may include a GFC module including a graphical user interface that provides instructional materials such as documents, videos, recordings, or any other media. A user profile module may enable users to sign up and create user profiles. A messaging module may include a means of facilitating a communication between educators and mentors, whether for help during the program, to obtain feedback, or to enable a collaborative effort between educator and mentor via the LMS. A grading module may include a means for mentors to grade educators and for educators to keep track of their progress. In one embodiment, software module 204 may include one or more instructions for: instructing an educator to observe a media presentation of a GFC conversation between GFC participants; providing media of the presentation including pre-recorded or live feeds of a GFC conversation between participants; instructing the educator to formulate their own GFC question set for initiating their own GFC conversation with a student of the educator; receiving feedback from the educator concerning a GFC conversation between participants; and authorizing the educator to conduct a GFC conversation including a GFC question set with the student.

Further, as will be explained below, an educator may need to evaluate a GFC conversation provided to the educator via media as part of their training using certain predetermined criteria. As such, software module 204 may be configured to provide instructions concerning their evaluations based on the criteria. Such instructions may include, for example: instructing the educator to determine whether a GFC conversation including a GFC question set affirms a participant; instructing the educator to determine whether a GFC conversation includes a reasoned statement from a first participant to a second participant for initiating a GFC conversation; instructing the educator to determine whether a participant of a GFC conversation utilized congruent verbal and non-verbal messages; instructing the educator to determine whether a participant of a GFC conversation utilized non-critical language; instructing the educator to determine whether a participant of a GFC conversation implemented a respectful tone; instructing the educator to determine whether a participant of a GFC conversation implemented an encouraging message into a GFC conversation.

Other instructions may be provided via the LMS to the mentoring clients as well. For example, a user interface may: instruct a mentoring client to observe a GFC conversation between the educator and a student of the educator; instruct a mentoring client to evaluate a GFC conversation based on the predetermined criteria; and instruct a mentoring client to provide feedback to the educator based on the observations and evaluation of the GFC conversation. These and other instructions that may be provided to the educator and to the mentor via the LMS, for example, via a user interface such as a web-based user interface that guides both the educator and mentoring client through a program of instruction.

Server 200 is configured to communicate with educator client 205 and mentor client 206. This may include hardware components and software components configured to communicate with server 200 in order to provide each type of user with access to server 200. Client devices suitable for communicating with server 200 may include desktop computers, laptops, smartphones, tablets or any other mobile device that may connect to a network such as the internet and access server 200.

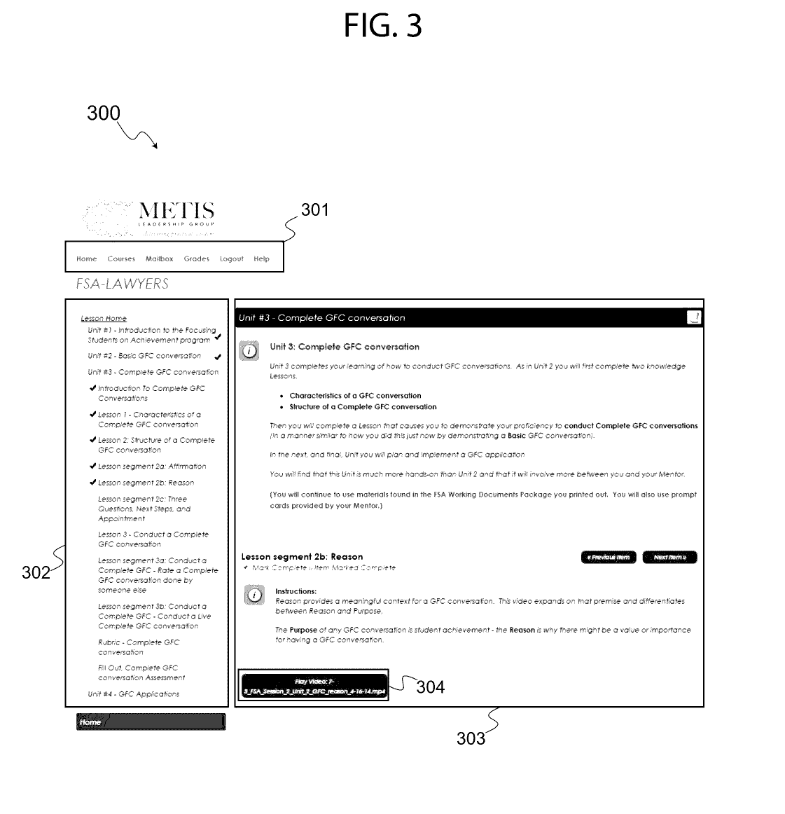

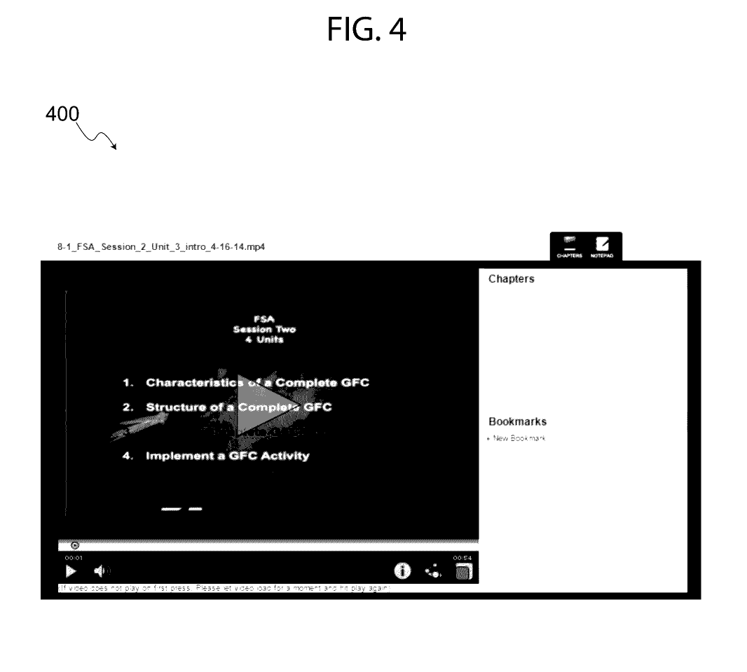

Turning to the next figures, FIG. 3 and FIG. 4 illustrate embodiments of a user interface in accordance with the present invention. More specifically, FIG. 3 shows graphical user interface (GUI) 300, which may be hosted by a server of the service provider and provided via a website on the World Wide Web, or via a mobile device application for a smartphone or tablet. GUI 300 may include a navigational component 301, a progress indicator 302, an instructional window 303 as well as interactive media access 304 for facilitating a training session. GUI 300 may also include an interface 400 for showing instructional material that includes media—such as a media player for showing pre-recorded, or live feeds of, GFC conversations between participants.

Access to the tools offered by different aspects of the software may be provided via GUI 300. For example, the GUI may provide a messaging component for educators to obtain guidance or feedback from their mentors. Similarly, the GUI may provide access to the user's grades and profile information. As is typical of web-based interfaces, the various features and tools of GUI 300 may be accessed via a navigational component 301.

In exemplary embodiments, the user interface may provide a means for educators to learn the knowledge and skills necessary to achieve the program's outcomes by engaging in the three following activities: (1) educators may observe a GFC conversation at the career, school, and/or classroom level; (2) educators may evaluate a GFC conversation at the career, school, and/or classroom level; and (3) educators may plan and implement a GFC conversation in her/his own educational environment (classroom, counseling session, school, after school activity, etc.)—all under the guidance and/or assistance of a mentor that has been paired with the educator via the LMS. For example, and without limiting the scope of the present invention, GUI 300 may provide a program or curriculum for each educator. Such program may be divided into multiple units of instruction. In exemplary embodiments, the program is divided into four units as follows: Unit 1 may consist of an introduction to the program; Unit 2 may consist of a basic GFC protocol and instruct the educator to watch or observe a pre-recorded, or live feed of, a GFC conversation; Unit 3 may consist of requiring the educator to evaluate the GFC protocol; and Unit 4 may consist of allowing the educator to create and or apply at least one GFC conversation including a GFC protocol with one of their one students. The progress of each educator's curriculum may be displayed in a progress indicator 302.

In an exemplary embodiment, content may be presented in a linear fashion and a client or user must acknowledge completion of the lesson element or unit tasks. An administrator and, in some cases the assigned mentor, may observe if the educator is just clicking through without viewing the instructional materials. Of course, in other embodiments, restricted access to following sections of the lessons may not be required.

Instructional information, such as instructions on what steps to take next, lesson plans, schedules, or any other type of instructional information may be offered to educator clients via instructional window 303. In exemplary embodiments, at a particular lesson of one or more of the units, the educator may be prompted or directed to download, or otherwise be provided with materials such as instructional materials or documents for working with the program. For example, and without deviating from the scope of the invention, the working documents may include a syllabus, a skill sheet, rubrics, or any other useful information that may facilitate the training.

Since GFC conversations must be observed by the educators in order to complete their training, GUI 300 may facilitate presenting the GFC conversations either by enabling a live feed of a live GFC conversation between participants, or by providing media of recorded GFC conversations that demonstrate use of the GFC protocol or question set. As such, by way of example, GUI 300 may include links, buttons or any type of interactive media access means 304 to facilitate the viewing or observation of the GFC conversations to the educators. In some embodiments, because the mentor may further want to observe the educator initiating their own GFC conversation, GUI 300 may provide a similar means for the mentor to view the educator's GFC conversation; this may similarly be achieved by enabling live feeds, or recorded videos that may be provided to the mentor client via the LMS.

Accordingly, GUI 300 and media player 400 are just two examples of well-known vehicles for providing the program's materials.

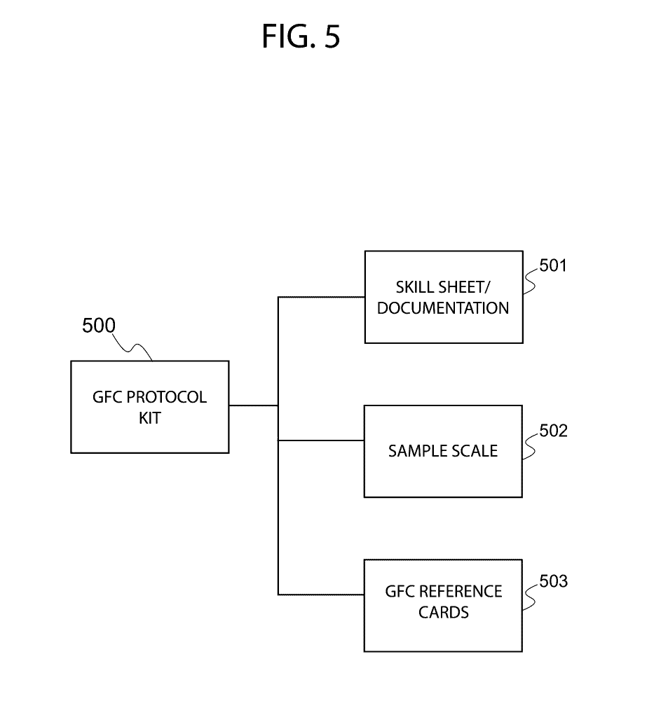

Turning now to FIG. 5, a block diagram depicts a kit-component of a system in accordance with the present invention, wherein the kit may be provided to educators during their training, but may also be used by educators that continue to practice the GFC protocol in the field. As shown, a GFC protocol kit 500 in accordance with the present invention may include a skill sheet 501 or documentation for the student to fill out, discuss with their mentor, and use during training. Also, a sample scale 502 may be included, which the educator may use when practicing with their students during a live session. Furthermore, a kit in accordance with the invention may include reference cards 503 for the educator to refer to as an aid or guide to the GFC protocol structure and procedure.

In exemplary embodiments, components of the kit may be provided both electronically and physically. For example, the service provider may deliver envelopes including these materials for live one-on-one mentoring sessions, or during the training of future mentors at an institution. Moreover, the materials may be provided via downloadable files accessible through the user interface to the LMS.

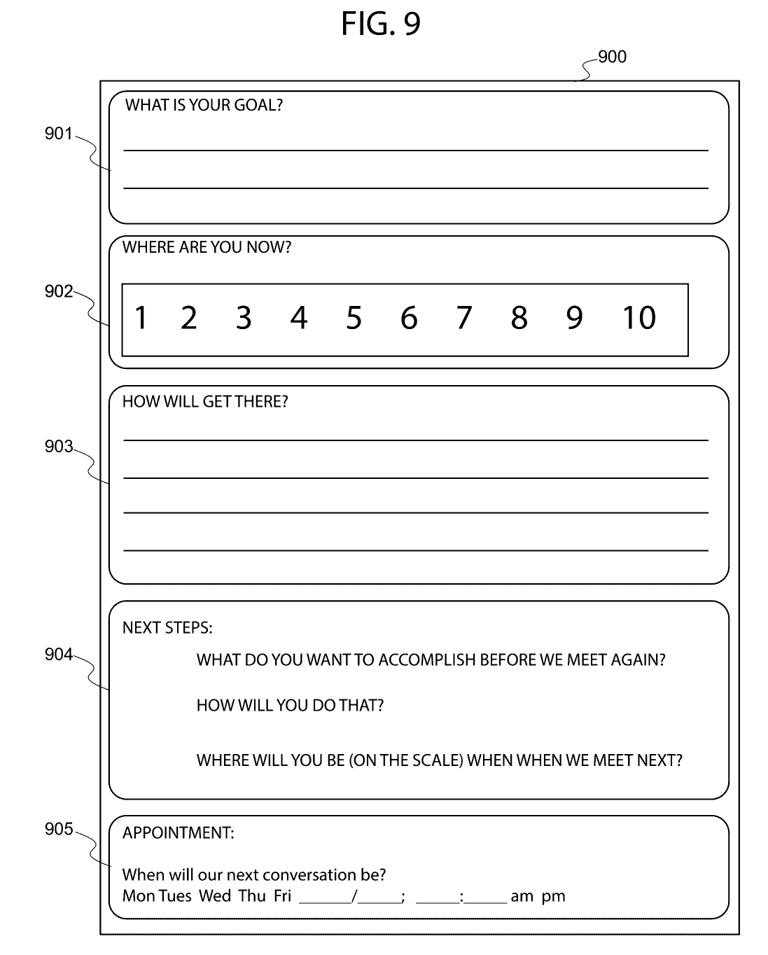

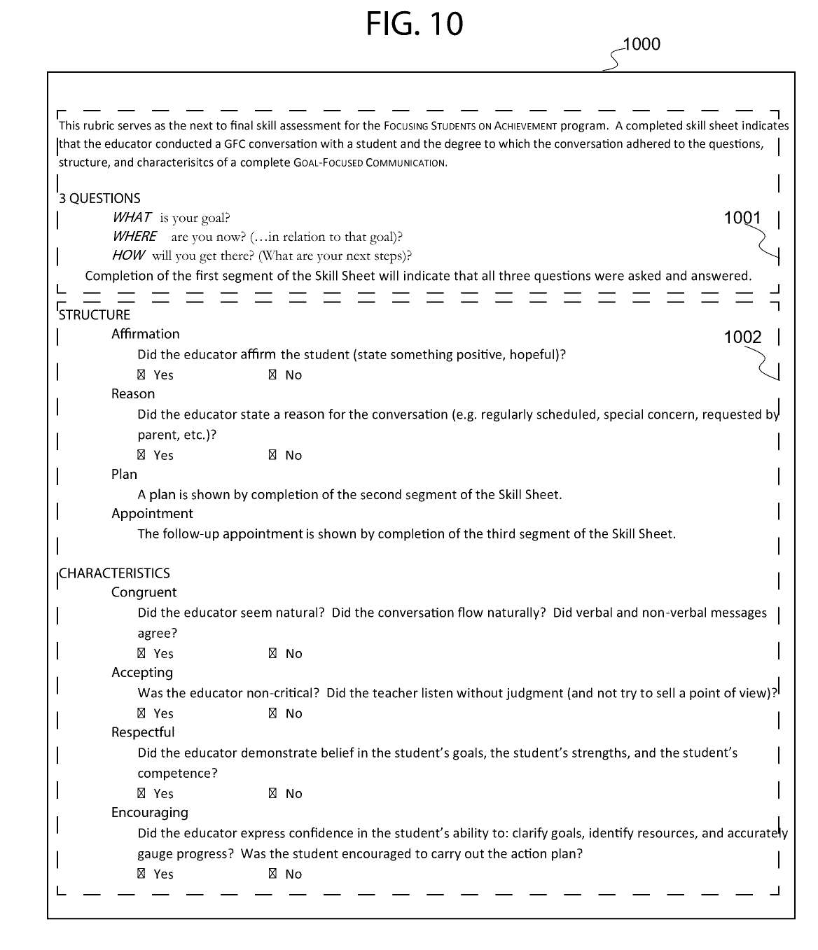

A skill sheet 501 or working documentation may include an instructional portion, a syllabus, a worksheet that may be filled out by the educator, and questions designed to engage the educator with the program. Exemplary skill sheets and evaluation forms that may be included with the documentation of kit 500 are illustrated in FIG. 9 and FIG. 10.

A sample scale 502 may be useful for the educator to have a prop during live GFC protocol practice. Such scale may be a simple visual tool including numbering between 1 and 10 as a reference for the student when asked questions during the GFC protocol. A sample of a simple scale is included in the exemplary skill sheet depicted in FIG. 9.

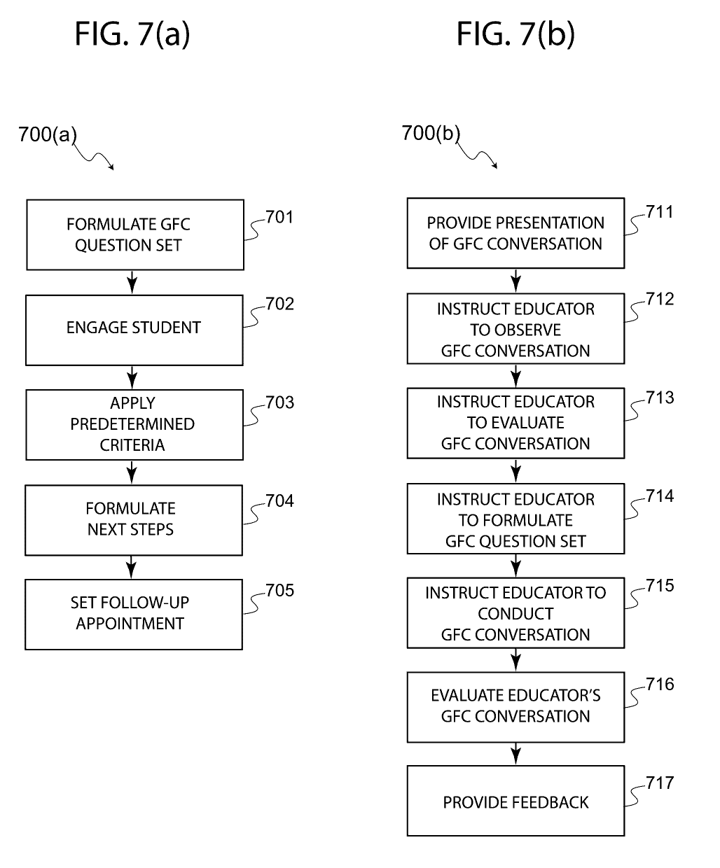

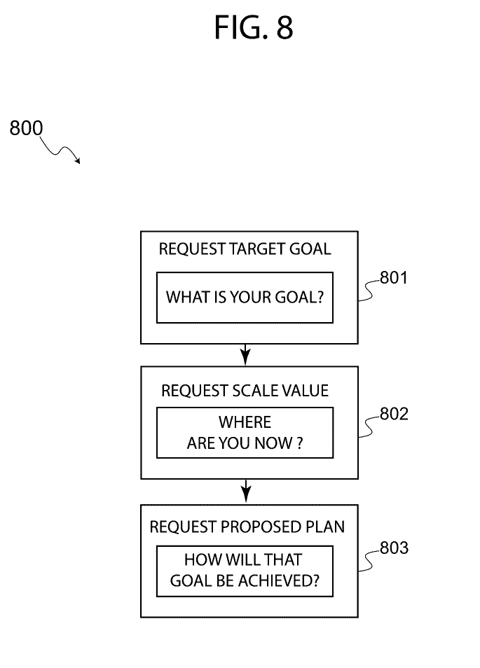

GFC reference cards 503 may also be included in the GFC kit. The GFC reference cards may list out the GFC protocol structure, provide sample questions, and an outline of the GFC protocol for the educator to follow and use as a check list. For example, and without limiting the scope of the present invention, GFC reference cards 503 may include guidelines relevant to predetermined criteria that should be used in implementing the GFC question set discussed below with reference to FIG. 7, or guidelines relevant to the questions that may be formulated for a GFC protocol conversation as discussed below with reference to FIG. 8, or guidelines relevant to any of the steps required of a complete GFC protocol.

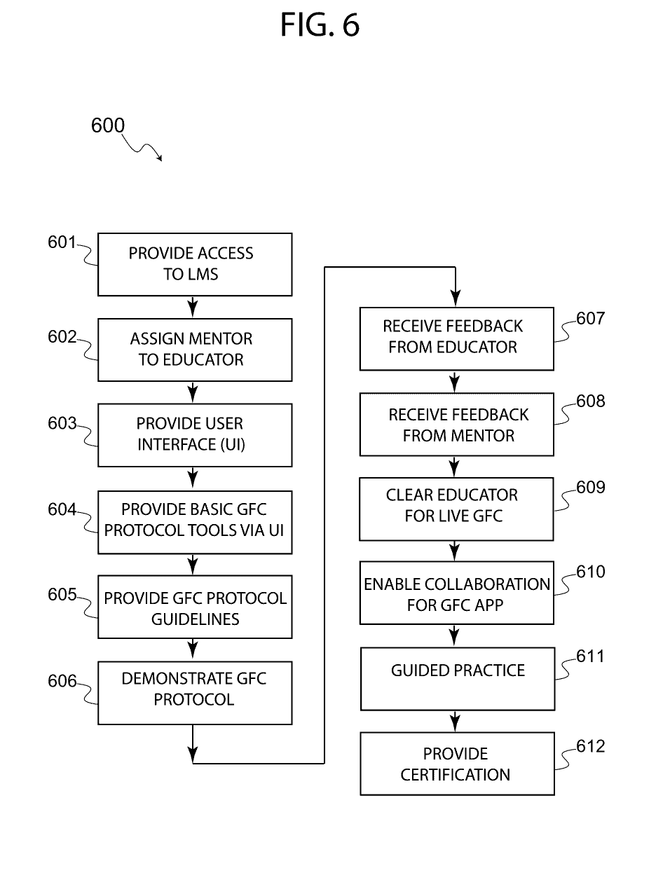

Next, FIG. 6 is a flowchart depicting a method for training educators, in accordance with practice of one embodiment of the present invention. In such exemplary embodiment, method 600 comprises the steps of: providing mentor and an educator access to a learning management server; assigning an educator-client to a mentor-client; providing a user interface accessible via the learning management server; providing instruction materials associated with a GFC protocol via the user interface; providing a set of GFC guidelines via the user interface; providing, to the educator-client, a demonstration associated with a GFC protocol; receiving feedback from the educator-client concerning the demonstration; receiving feedback from the mentor-client; approving the educator-client for a live GFC protocol; enabling collaboration between mentor-client and educator-client; and providing certification of completion to the educator-client.

Method 600 may be performed in the following sequence, but it is understood that the following steps may be performed in alternate sequences without deviating from the scope of the present invention.

In step 601, providing a mentor and an educator access to a learning management server may comprise of providing a server and authorizing an institution, such as a school or school district, with access to that server in order to enable the institution to sign up their educators. The service provider may train institution educators to be mentors for their own educators, or may supply mentors to train the educators of the institution.

In step 602, assigning an educator-client to a mentor-client may comprise of associating a unique user identifier to each of the system's participants, such as mentor-clients and educator-clients. A single mentor may be assigned to a single educator, or one mentor may be assigned to multiple educators. By associating a unique ID between mentors and educators, the system will be able to direct communications between the clients of the systems to the correct party.

In step 603, providing a user interface accessible via the learning management server may comprise providing a suitable interface such as a website or a mobile device application. Typically, providing a user interface may include providing a GUI that enables the service provider to display instructional information to the system's clients, including navigational features to keep track of their progress in the program, as well as media—such as video- to display a demonstration of the GFC protocol used in a GFC conversation. The user interface or GUI may include tools such as note taking capabilities for users that view videos or lecture materials.

In step 604, providing instruction materials associated with a GFC protocol via the user interface may comprise downloadable content, such as skill sheets or workbooks, or any other documentation that may be beneficial for learning the GFC protocol throughout the program's lessons.

In step 605, providing a set of GFC guidelines via the user interface may comprise of displaying, listing, demonstrating or otherwise providing instructions concerning how to utilize a GFC protocol when teaching students. These instructions may include, for example: formulating a question set; engaging a student; applying a set of predetermined criteria to the question set; formulating follow-up procedures; and setting up an appointment to re-engage with the student, wherein the question set comprises: requesting a target goal; requesting a scale value; and requesting a proposed plan to achieve the target goal. This step may provide documentation explaining a set of criteria that may be used in evaluating a GFC conversation, as well as in implementing a GFC question set (when the educator is ready to initiate a GFC conversation with their student).

In step 606, providing, to the educator-client, a demonstration associated with a GFC protocol may comprise displaying a live or video demonstration of a GFC conversation. For example, and without limiting the scope of the present invention, in this step a video may present a pre-recorded conversation between a previously trained educator and their student (or participants), in which one participant utilizes a GFC question set throughout his or her conversation with the student.

In step 607, receiving feedback from the educator-client concerning the demonstration may comprise receiving input from the educator-client concerning any demonstration or sample GFC conversation that has been presented to the educator for learning purposes. For example, and without limiting the scope of the present invention, in this step, the educator may provide feedback concerning the video presented to the educator in a previous step. In one embodiment, the educator-client may provide feedback via a downloadable form. In another embodiment, the educator-client may provide feedback via input directly through the GUI. In yet another embodiment, the educator-client may provide feedback by utilizing a messaging system and messaging the educator's mentor.

In step 608, receiving feedback from the mentor-client may comprise receiving any input from the mentor concerning the feedback provided by the educator. That is, the mentor may provide observations concerning the feedback from the educator. Whether received via a form, a message, or directly via the GUI, the mentor may use these observations to further instruct the educator and provide a learning opportunity. In one embodiment, the mentor-client may provide feedback to the educator via a downloadable form. In another embodiment, the mentor-client may provide feedback via input directly through the GUI. In yet another embodiment, the mentor-client may provide feedback by utilizing a messaging system and messaging the educator.

In step 609, approving the educator-client for a live GFC conversation may comprise receiving from the mentor an approval for the educator to conduct a live GFC conversation with another individual. In this step, the mentor may have decided that the educator properly understands the GFC protocol and is ready to practice.

In step 610, enabling collaboration between mentor-client and educator-client may comprise enabling a means of communication between the mentor and the educator so that the educator can design their own application of a GFC protocol to practice with another individual. In one embodiment, this step may include enabling a messaging module for the educator and mentor to communicate. In another embodiment, this step may include enabling a means of providing documents between educator and mentor, a live video and/or audio feed, or any other means of enabling the educator to collaborate with the mentor so that the educator may present their proposed GFC application and obtain approval and/or any final feedback from the educator's mentor.

In step 611, the educator may conduct one or more GFC conversations with students, focusing on career, school, and classroom goals as a summative indicator that requisite knowledge and application has been demonstrated. This face-to-face guided practice, facilitated by the mentor, may be an actual demonstration of one or more GFC conversations by the educator. The mentor may provide constructive feedback based on a GFC rubric such as the sample depicted in FIG. 10.

In step 612, providing certification of completion to the educator-client may comprise any means of certifying the educator as having completed the service provider's training program. This may include providing a downloadable certificate, a print out of the certificate, or ordering a certificate of completion from the service provider to be mailed to the student. Any means of providing a certification of completion may be suitable.

Next, FIG. 7(a) is a flowchart depicting a method for facilitating a GFC conversation, in accordance with practice of one embodiment of the present invention. In such exemplary embodiment, method 700(a) comprises the steps of: formulating a GFC question set; engaging a student; applying a set of predetermined criteria to the question set; formulating follow-up procedures; and setting up an appointment to re-engage with the student, wherein the question set comprises: requesting a target goal; requesting a scale value; and requesting a proposed plan to achieve the target goal.

Method 700(a) may be performed in the following sequence, but it is understood that the following steps may be performed in alternate sequences without deviating from the scope of the present invention.

In step 701, formulating a question set may comprise formulating several questions that (i) create a productive relationship between the educator and student (target of the GFC), (ii) affirms the relevance of the school and the classroom to the student's personal goals, (iii) allocates the locus of responsibility for learning to the student rather than the educator, (iv) enables the student to focus on personal goals (i.e. as opposed to goals dictated solely by the educator), (v) enables the student to identify relevance for their own learning, (vi) enables the student to take responsibility for their own learning, and (vii) enables the student to employ a sound plan for achieving their personal goals. In exemplary embodiments, the question set comprises: requesting a target goal; requesting a scale value; and requesting a proposed plan to achieve the target goal. Moreover, this question set (or three requests) is preferably provided in this particular order. Several examples are provided below with reference to FIG. 8.

In step 702, engaging a student may comprise instructions to engage in a conversation with a student of the educator. For example, the educator may be instructed to find a suitable time in which to engage a student—this may be during a specified meeting between student and educator, at the end of a classroom period, during breaks in a hallway, selected times during class, or even spontaneously when following up with a student.

In step 703, applying a set of predetermined criteria to the question set may comprise explaining and or instructing on the several criteria of a GFC conversation, which may be explained by way of a mnemonic used to cue the educator when conducting a complete GFC conversation. While there is no assessment of this knowledge content, when the educator demonstrates complete GFC conversations and is rated by the rubric, these criteria may be considered in the rating scheme. For example, and without limiting the scope of the present invention, the criteria may include the characteristics of caring or congruency, accepting, respectfulness, and encouragement. Of course, these and other terms may be used to convey proper characteristics of the GFC protocol. Typically, the criteria may be defined as follows:

Congruent: utilizing verbal and nonverbal messages that agree, forming a conversation that is authentic and flows naturally. Examples of instructions that may be provided to the educator include: sitting up, leaning in, making eye contact, and using their own words as opposed to having written dialogue prepared before the conversation. Examples of appropriate dialogue may include: “tell me more about that” or “what will be the next thing you do to get what you want?”

Accepting: listening without judgment and using non-critical language and tone during a GFC conversation. Examples of instructions that may be provided to the educator include: avoid trying to persuade the student to buy into the educator's ideas, and avoid critiquing the student's ideas. Examples of appropriate dialogue may include: “you are at a ‘10’ now” or “you believe the best way for you to make that improvement is . . . ”

Respectful: demonstrating that the educator believes the student has valid goals, strengths and personal resources; and demonstrating that the educator believes the student is competent to speak for themselves. Examples of appropriate dialogue may include: “would it be OK with you if I ask you a few things?” or “I'm glad to see you so on task today” or: “I'm confident that you can reach your goal.”

Encouraging: expressing confidence in the student's ability to clarify goals, identify resources, and accurately gauge progress; and expressing confidence in the student's ability to carry out their action plan. Examples of appropriate dialogue may include: “I'm sure when we meet tomorrow you'll have done what you said” or “I have every confidence you'll be at your goal by this time next week” or “I can't wait to celebrate with you!”

Of course, these and other terms may be used to convey proper characteristics of the GFC protocol, and alternative acronyms or mnemonic may be implemented without deviating from the scope of the present inventions, so long as the instructions carry the guidelines provided above.

In steps 704 and 705, formulating follow-up procedures and setting up an appointment to re-engage with the student may comprise of instructions to enable the educator to follow-up with the student for a follow-up GFC conversation. As will be apparent from the discussion below, the educator may be instructed to follow the GFC protocol with regards to this step as well or any time when setting up a future appointment.

Similarly, FIG. 7(b) is a flowchart depicting a method for training an educator to improve their students' achievement using GFC conversations, in accordance with practice of one embodiment of the present invention. In such exemplary embodiment, method 700(b) comprises the steps of: providing a presentation of a GFC conversation between two GFC participants; instructing the educator to observe the GFC conversation between the GFC participants; instructing the educator to evaluate the GFC conversation based on predetermined criteria; instructing the educator to formulate their own GFC question set for initiating a GFC conversation with a student of the educator; instructing the educator to conduct their own GFC conversation; and observing, by the mentor, and evaluating the educator's GFC conversation in order to provide the educator with feedback.

In step 711, providing a presentation of a GFC conversation between two GFC participants (an educator-participant that poses the GFC question set, and a student-participant that provides answers to the GFC question set during the GFC conversation) may include providing either media such as recorded videos of participants engaging in a GFC conversation, or providing live presentations of the same.

In step 712, instructing the educator to observe the GFC conversation between the GFC participants may include providing detailed instructions via an LMS or verbally (i.e. in a live setting), which indicate the criteria the educator will be using to evaluate the GFC conversation per step 713. For example, this may include live instruction or documented instructions outlining the predetermined criteria that make for an effective GFC conversation. This may include going over a skill sheet such as skill sheet 900 or an evaluation sheet such as evaluation sheet 1000.

In step 713, instructing the educator to evaluate the GFC conversation based on predetermined criteria may include an instruction to fill-out evaluation sheet 1000 and evaluate the performance of the participant that conducted the GFC conversation. Moreover, this step instructs the educator to make determinations based on his or her observations of the GFC conversation, the determinations based on one or more criteria necessary for a successful GFC conversation.

For example, the evaluator may be instructed to determine: whether the GFC conversation including the GFC question set affirms the participant; whether the GFC conversation includes a reasoned statement from the educator-participant to the student-participant for initiating the GFC conversation; whether the educator-participant of the GFC conversation utilized congruent verbal and non-verbal messages; whether the educator-participant of the GFC conversation utilized non-critical language; whether the educator-participant of the GFC conversation implemented a respectful tone; and or whether the educator-participant of the GFC conversation implemented an encouraging message into the GFC conversation.

In step 714, instructing the educator to formulate their own GFC question set for initiating a GFC conversation with a student of the educator may include several sub-steps such as receiving feedback from the educator concerning the GFC conversation between participants, and communicating or collaborating with the educator to go over the educator's proposed GFC question set.

In step 715, instructing the educator to conduct their own GFC conversation may include authorizing the educator to conduct their own GFC conversation including the GFC question set formulated per the instructions in step 714.

In step 716, observing, by the mentor, and evaluating the educator's GFC conversation in order to provide the educator with feedback may include simply evaluating the GFC conversation between the educator and a student based on the predetermined criteria—the mentor may typically use a similar rubric or evaluation sheet such evaluation sheet 1000. Moreover, the mentor may provide feedback to the educator based on the observations and evaluation of the GFC conversation in step 717.

Turning now to the next figure, FIG. 8 is a flowchart depicting a GFC question set or protocol for initiating a GFC conversation, in accordance with practice of one embodiment of the present invention. In such exemplary embodiment, method 800 comprises the steps of: requesting a target goal of a participant; requesting a scale value associated with the participant's perceived proximity to achieving the target goal; and requesting a plan of the participant to achieve the target goal. Typically, and preferably, these questions are posed in this order so as to properly guide the participant or student to focus on their goals.

In step 801, requesting a target goal may comprise of any question or inquiry that elicits or clarifies short-term or long-term goals of the student. For example, and without limiting the scope of the present invention, this request may be stated as follows: “What is your goal?” or “What is the main benefit you want for yourself from this class (this school, this year, etc.)?” or “What would a picture of that look like?” or “What will you be doing when you reach your goal?” Hence a simple inquiry into the goal of the student may be a proper request under this step.

In step 802, requesting a scale value may comprise of any question that uses a scale to show a current status or progress of the student. For example, and without limiting the scope of the present invention, this request may be stated as follows: “Where are you now?” or “On a scale from one to ten (if 10 is meeting your goal and one is the first step to attaining that goal), where are you now?” or “Where are you on the scale today?” if following up. Hence a simple inquiry into the current status or progress of the student may be a proper request under this step.

In step 803, requesting a proposed plan to achieve the target goal may comprise of any question that identifies a successful behavior of the student. For example, and without limiting the scope of the resent invention, this request may be stated as follows: “How will you get there?” or “How will you move closer to that goal?” or “What might you try next to move up the scale?” or “What behaviors have you seen in others that might work for you now?” Hence a simple inquiry that identifies what the student believes are successful behaviors may be a proper request under this step.

Similarly, initiating a follow-up procedure or “Next Steps” procedure whereby the educator intends to set up an appointment with the GFC target, may include formulating similar questions. For example, and without limiting the scope of the present invention, those questions may include: “WHAT do you want to accomplish before we meet again?” “HOW will you do that?” and “WHERE will you be (on the scale) when we meet next week?”

Different versions and configurations of a program or curriculum may be provided without deviating from the scope of the invention. For example, the program may be delivered in multiple forms to an educator. That is, an educator may be provided with a presenter version, and a blended-learning version of the program.

In one exemplary embodiment, the service provider may provide a presenter version of the program. In the presenter version a mentor may conduct an on-site, face-to-face training providing knowledge and skill acquisition and guided practice of the application of those skills and knowledge. This format may be used for small groups of 8-12 educators. These educators may directly apply this training to students in their school and classrooms.

In one exemplary embodiment, the service provider may provide a blended-learning version of the program. In the blended-learning version when a school or district desires to build and sustain its own staff development capacity by training their own mentors, the service provider may offer the blended-learning version, which includes the on-site, face-to-face, training described above, plus training in mentoring, training in facilitating the program via an LMS, and training in the conducting practice in accordance with the present invention.

FIG. 9 illustrates a sample skill sheet that may be provided to an educator while they work through the program. More specifically, skill sheet 900 may include several fill-in sections for guiding an educator through the GFC protocol or GFC question set, including a visual aid scale, which they may use when they practice their GFC conversation. Accordingly, each sections 901, 902, 903, 904, and 905, may correspond to a question of a GFC question set, or a step in a GFC protocol. For example, skill sheet 900 may include a section corresponding to for a first request for a target goal of a participant; a section 902 corresponding to a second request for a scale value associated with the participant's perceived proximity to achieving the target goal requested in section 901; a section 903 may correspond to a third request for a plan of the second participant to achieve the target goal; section 904 may correspond to a second set of GFC questions or follow-up GFC questions regarding the plan outlined in section 903; and section 905 corresponding to a set appointment for the educator to meet and follow-up with the student.

Documentation such as skill sheet 900 may be provided to educator clients via the LMS so that they may practice, and evaluate GFC conversations provided to them. Additionally, educators and mentors alike may use the GFC rubric, including several predetermined criteria, for evaluating observed GFC conversations.

FIG. 10 illustrates an exemplary evaluation form, or rubric for evaluating each GFC conversation. As mentioned above, the rubric focuses the evaluator (whether an educator that has observed a sample recorded or live GFC conversation, or a mentor that has observed an educator perform their own GFC conversation with an educator client) on the various parameters such as the structure and characteristics of each GFC conversation.

For example, evaluation form 1000 may comprise of two sections 1001 and 1002. Section 1001 may include instructions as well as a guide of the GFC question set in a simple format for the evaluator to use while observing the GFC conversation and making sure each request of the question set was posed in the correct order during the conversation.

Section 1002 may be a checklist, with definitions of terms and criteria for evaluating each GFC conversation by determining whether the criteria required was met.

Predetermined criteria may include affirmation—as such, section 1002 may include a checklist to allow the evaluator to determine whether the GFC conversation including the GFC question set affirms the participant. As shown in evaluation form 1000, this means whether the educator-participant state something positive or hopeful during the conversation.

Predetermined criteria may include providing a reasoned statement—as such, section 1002 may include a checklist to allow the evaluator to determine whether the GFC conversation includes a reasoned statement from the educator-participant to the second participant for initiating the GFC conversation. As shown in evaluation form 1000, this may mean whether the educator-participant stated a reason for the conversation such as a regularly or pre-scheduled event, special concerns with the student, requested by either party, etc.

Predetermined criteria may include congruency—as such, section 1002 may include a checklist to allow the evaluator to determine whether the educator-participant of the GFC conversation utilized congruent verbal and non-verbal messages. As shown in evaluation form 1000, this means whether the educator-participant utilize congruent verbal and non-verbal messages so as to allow the GFC conversation to flow naturally.

Predetermined criteria may include acceptance or non-critical language—as such, section 1002 may include a checklist to allow the evaluator to determine whether the educator-participant of the GFC conversation utilized non-critical language. As shown in evaluation form 1000, this means whether the educator-participant listened without judgement, not try to sell their point of view, and was not critical.

Predetermined criteria may include respectfulness—as such, section 1002 may include a checklist to allow the evaluator to determine whether the educator-participant of the GFC conversation implemented a respectful tone. As shown in evaluation form 1000, this means whether the educator-participant demonstrate belief in the student-participant's goals, strengths, and the student-participant's competence.

Predetermined criteria may include encouragement—as such, section 1002 may include a checklist to allow the evaluator to determine whether the educator-participant of the GFC conversation implemented an encouraging message into the GFC conversation. As shown in evaluation form 1000, this means whether the educator-participant expressed confidence in the student's ability to clarify goals, identify resources, and accurately gauge progress. For example, during the GFC conversation whether the educator-participant encourage the student to carry out the action plan.

Of course, evaluation form 1000 including a list of the various predetermined parameters for evaluating a GFC conversation may be provided in a variety of formats without deviating from the present invention. This information may be presented on-line via an LMS, in person, or via a mixture of live communications and electronic formats.

A system and method for teaching and implementing an interactive goal-focused communication protocol has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A method for training an educator to improve their students' achievement using goal-focused communication (GFC) conversations, comprising the steps of:
instructing the educator to observe a presentation of a first GFC conversation between GFC participants, wherein the first GFC conversation includes a first GFC question set initiated by a first participant and comprising of:
a first request for a target goal of a second participant,
a second request for a scale value associated with the second participant's perceived proximity to achieving the target goal, and
a third request for a plan of the second participant to achieve the target goal;
instructing the educator to evaluate the first GFC conversation based on predetermined criteria; and
instructing the educator to formulate a second GFC question set for initiating a second GFC conversation with a student of the educator.

2. The method of claim 1, further comprising:
receiving feedback from the educator concerning the first GFC conversation between the first and second participants; and
authorizing the educator to conduct the second GFC conversation including the second GFC question set with the student.

3. The method of claim 1, wherein the step of instructing the educator to evaluate the first GFC conversation based on predetermined criteria comprises:
instructing the educator to determine whether the first GFC conversation including the first GFC question set affirms the second participant.

4. The method of claim 1, wherein the step of instructing the educator to evaluate the first GFC conversation based on predetermined criteria comprises:
instructing the educator to determine whether the first GFC conversation includes a reasoned statement from the first participant to the second participant for initiating the first GFC conversation.

5. The method of claim 1, wherein the step of instructing the educator to evaluate the first GFC conversation based on predetermined criteria comprises:
instructing the educator to determine whether the first participant of the first GFC conversation utilized congruent verbal and non-verbal messages.

6. The method of claim 1, wherein the step of instructing the educator to evaluate the first GFC conversation based on predetermined criteria comprises:
instructing the educator to determine whether the first participant of the first GFC conversation utilized non-critical language.

7. The method of claim 1, wherein the step of instructing the educator to evaluate the first GFC conversation based on predetermined criteria comprises:
instructing the educator to determine whether the first participant of the first GFC conversation implemented a respectful tone.

8. The method of claim 1, wherein the step of instructing the educator to evaluate the first GFC conversation based on predetermined criteria comprises:
instructing the educator to determine whether the first participant of the first GFC conversation implemented an encouraging message into the first GFC conversation.

9. The method of claim 2, further comprising:
observing the second GFC conversation between the educator and the student;
evaluating the second GFC conversation based on the predetermined criteria; and
providing feedback to the educator based on the observations and evaluation of the second GFC conversation.

10. The method of claim 9, wherein the step of evaluating the second GFC conversation based on the predetermined criteria comprises:
determining whether the second GFC conversation including the second GFC question set affirms the student.

11. The method of claim 9, wherein the step of evaluating the second GFC conversation based on the predetermined criteria comprises:
determining whether the second GFC conversation includes a reasoned statement from the educator to the student for initiating the second GFC conversation.

12. The method of claim 9, wherein the step of evaluating the second GFC conversation based on the predetermined criteria comprises:
determining whether the educator utilized congruent verbal and non-verbal messages in the second GFC conversation.

13. The method of claim 9, wherein the step of evaluating the second GFC conversation based on the predetermined criteria comprises:
determining whether the educator utilized non-critical language.

14. The method of claim 9, wherein the step of evaluating the second GFC conversation based on the predetermined criteria comprises:
determining whether the educator implemented a respectful tone.

15. The method of claim 9, wherein the step of evaluating the second GFC conversation based on the predetermined criteria comprises:
determining whether the educator implemented an encouraging message into the second GFC conversation.

16. A method for training an educator to improve their students' achievement using recorded goal-focused communication (GFC) conversations presented via a learning management system, comprising the steps of:
instructing the educator to observe a media presentation of a first GFC conversation between GFC participants, wherein the first GFC conversation includes a first GFC question set initiated by a first participant and comprising of:
a first request for a target goal of a second participant,
a second request for a scale value associated with the second participant's perceived proximity to achieving the target goal, and
a third request for a plan of the second participant to achieve the target goal;
instructing the educator to evaluate the first GFC conversation based on predetermined criteria;
instructing the educator to formulate a second GFC question set for initiating a second GFC conversation with a student of the educator;
observing a live demonstration of the second GFC conversation between the educator and the student;
evaluating the second GFC conversation based on the predetermined criteria; and
providing feedback to the educator based on the observations and evaluation of the second GFC conversation.

17. The method of claim 16, wherein the step of instructing the educator to evaluate the first GFC conversation based on predetermined criteria comprises:
instructing the educator to determine whether the first GFC conversation including the first GFC question set affirms the second participant;
instructing the educator to determine whether the first GFC conversation includes a reasoned statement from the first participant to the second participant for initiating the first GFC conversation;
instructing the educator to determine whether the first participant of the first GFC conversation utilized congruent verbal and non-verbal messages; and
instructing the educator to determine whether the first participant of the first GFC conversation utilized non-critical language.

18. The method of claim 16, wherein the step of evaluating the second GFC conversation based on the predetermined criteria comprises:
determining whether the second GFC conversation including the second GFC question set affirms the student;
determining whether the second GFC conversation includes a reasoned statement from the educator to the student for initiating the second GFC conversation;
determining whether the educator utilized congruent verbal and non-verbal messages in the second GFC conversation; and
determining whether the educator utilized non-critical language.

19. The method of claim 16, further comprising:
receiving feedback from the educator concerning the first GFC conversation between the first and second participants; and
authorizing the educator to conduct the second GFC conversation including the second GFC question set with the student prior to observing the live demonstration.

20. A method for training an educator to improve their students' achievement using recorded goal-focused communication (GFC) conversations presented via a learning management system, comprising the steps of:
instructing the educator to observe a media presentation of a first GFC conversation between GFC participants, wherein the first GFC conversation includes a first GFC question set initiated by a first participant and comprising of:
a first request for a target goal of a second participant,
a second request for a scale value associated with the second participant's perceived proximity to achieving the target goal, and
a third request for a plan of the second participant to achieve the target goal;
instructing the educator to evaluate the first GFC conversation based on predetermined criteria; and
instructing the educator to formulate a second GFC question set for initiating a second GFC conversation with a student of the educator, wherein the predetermined criteria include: providing an affirmation, providing a reasoned statement for initiating the first or second GFC conversations, utilizing congruent verbal and non-verbal messages in the GFC conversation; and utilizing non-critical language.
